(19) United States
(12) Patent Application Publication
(10) Pub. No.: US 2011/0253809 A1
(43) Pub. Date: Oct. 20, 2011

(54) PRESSURE SWIRL ATOMIZER WITH SWIRL-ASSISTING CONFIGURATION

(76) Inventors: Daniel William Bamber, St. Clair Shores, MI (US); Steven Lee Ambrose, Farmington Hills, MI (US); Dale Arden Stretch, Novi, MI (US)

(21) Appl. No.: 13/087,840

(22) Filed: Apr. 15, 2011

Related U.S. Application Data
(60) Provisional application No. 61/325,421, filed on Apr. 19, 2010.

(51) Int. Cl. B05B 1/26

(52) U.S. Cl. 239/518

(57) ABSTRACT

A pressure swirl atomizer has a swirl chamber with an exit orifice and a plurality of tangential swirl channels disposed around the circumference of the swirl chamber. A pintle bearing surrounds a pintle. The pintle has a body portion and a nose portion that is narrower than the body portion. The nose portion has a tip that opens and closes the exit orifice and a side that is movable in the pintle bearing. In one embodiment, a return path formed between the nose portion of the pintle and the pintle bearing drains fluid from the swirl chamber when the exit orifice is closed. The nose portion positions the return path closer to a centerline of the atomizer, forcing fluid to swirl in the swirl chamber before draining. Since the fluid does not remain static in the chamber, less energy is needed to increase the fluid velocity and quickly form a desired spray pattern when the exit orifice is opened.

### CROSS-REFERENCE TO RELATED APPLICATIONS

This application claims the benefit of U.S. Provisional application Ser. No. 61/325,421 filed Apr. 19, 2010 entitled INJECTOR FLUID RETURN WITH SWIRL ASSIST, the entire disclosure of which is hereby incorporated by reference herein.

### TECHNICAL FIELD

The present invention relates to pressure swirl atomizers, and more particularly to a pressure swirl atomizer having a geometry that provides improved spray quality.

### BACKGROUND OF THE INVENTION

Pressure swirl atomizers are used in various applications, including fuel injection systems and exhaust aftertreatment systems. Atomizers disperse fluid into a fine spray by directing fluid from tangential swirl channels into a swirl chamber and then opening a central exit orifice to allow the fluid to exit in a spray pattern. More particularly, the tangential swirl channels causes fluid entering the swirl chamber to swirl in a circular motion and increase its angular velocity as it moves toward the exit orifice. The centrifugal force generated by the swirling motion generates a low pressure zone along the central axis of the swirl chamber.

When the exit orifice is opened, exhaust gas enters the atomizer through the exit orifice and forms an air core through the exit orifice. The fluid forms a “wall” around the air core. Aerodynamic forces break the fluid wall into droplets after it exits the injector. The thickness of this fluid wall and the dimensions of the air core depend on the fluid supply pressure and on the ratio of the diameter of the swirl chamber and the diameter of the exit orifice, and these dimensions in turn control the characteristics of the spray pattern as fluid leaves the exit orifice.

A solenoid-controlled pintle opens and closes the exit orifice to allow or block fluid flow out of the atomizer. When the pintle is closed, the fluid drains through a return flow path to, for example, cool the solenoid. However, since the swirl chamber is designed for optimal flow profiles from the swirl channels to the exit orifice, closing the pintle interrupts this flow profile and creates a “dead” volume of static fluid within the swirl chamber where the fluid is essentially motionless. When the pintle moves back to the open position, the static fluid eventually accelerates to resume its swirling flow pattern, but some of the static fluid still escapes the exit orifice before the fluid swirl is completely formed. This results in a pulse of large, poorly distributed drops in the spray pattern when the exit orifice initially opens.

In many applications, this negative spray quality is not a concern because the pintle remains continuously open. However, in applications where a variable flow rate is desired, the exit orifice is opened and closed via pulse width modulation (PWM) of the pintle between the open and closed positions. The repeated opening and closing of the exit orifice creates more opportunities for dead volumes of fluid to accumulate and be released the next time the exit orifice is opened. As a result, currently known atomizers do not provide optimal spray quality for applications that vary the flow rate through PWM control.

There is a desire for a pressure swirl atomizer that provides consistent spray quality even when used in applications where the exit orifice is opened and closed during operation.

### SUMMARY OF THE INVENTION

One embodiment of the invention is directed to a pressure swirl atomizer has a swirl chamber with an exit orifice and a plurality of tangential swirl channels disposed around the circumference of the swirl chamber. A pintle bearing houses the pintle. The pintle has a body portion and a nose portion that is narrower than the body portion. The nose portion has a tip that opens and closes the exit orifice and a side that is movable in the pintle bearing. In one embodiment, a return path formed between the nose portion of the pintle and the pintle bearing drains fluid from the swirl chamber when the exit orifice is closed. The nose portion positions the return path closer to a centerline of the atomizer, forcing fluid to swirl in the swirl chamber before draining.

Since the fluid does not remain static in the chamber, less energy is needed to increase the fluid velocity and quickly form a desired spray pattern when the exit orifice is opened. This makes the atomizer suitable for applications where the exit orifice is repeatedly opened and closed because there is no loss in spray quality when the orifice is initially opened.

### BRIEF DESCRIPTION OF THE DRAWINGS

FIG. 1 is a sectional view of a pressure swirl atomizer according to one embodiment of the present invention;

FIG. 2 is a sectional view of a portion of a pressure swirl atomizer according to a prior art configuration;

FIG. 3 is a sectional view of a portion of a pressure swirl atomizer, as indicated in FIG. 1 as according to one embodiment of the invention;

FIG. 4 is a plan view of an underside of a nozzle according to one embodiment of the invention.

### DETAILED DESCRIPTION OF THE INVENTION

FIG. 2 illustrates a portion of a pressure swirl atomizer 10 having a currently-known configuration. The atomizer 10 has a pintle 12 disposed within a pintle bearing 14 that accommodate the pintle 12. The pintle bearing 14 can be any structure that guides movement of the pintle 12. In one embodiment, the pintle bearing 14 is a flux collector, but the pintle bearing 14 may have other functions without departing from the scope of the invention.

The pintle 12 is movable to open and close an exit orifice 15 in a nozzle 16. The nozzle 16 has a swirl chamber 18 to accelerate fluid in a swirl pattern before it exits the exit orifice 15 in a spray pattern. A narrower nose portion 19 of the pintle 12 extends out of the pintle bearing 14 to open and close the exit orifice 15 while allowing fluid to swirl around the nose portion 19. The pintle 12 also has a body portion 20 that moves within the pintle bearing 14.

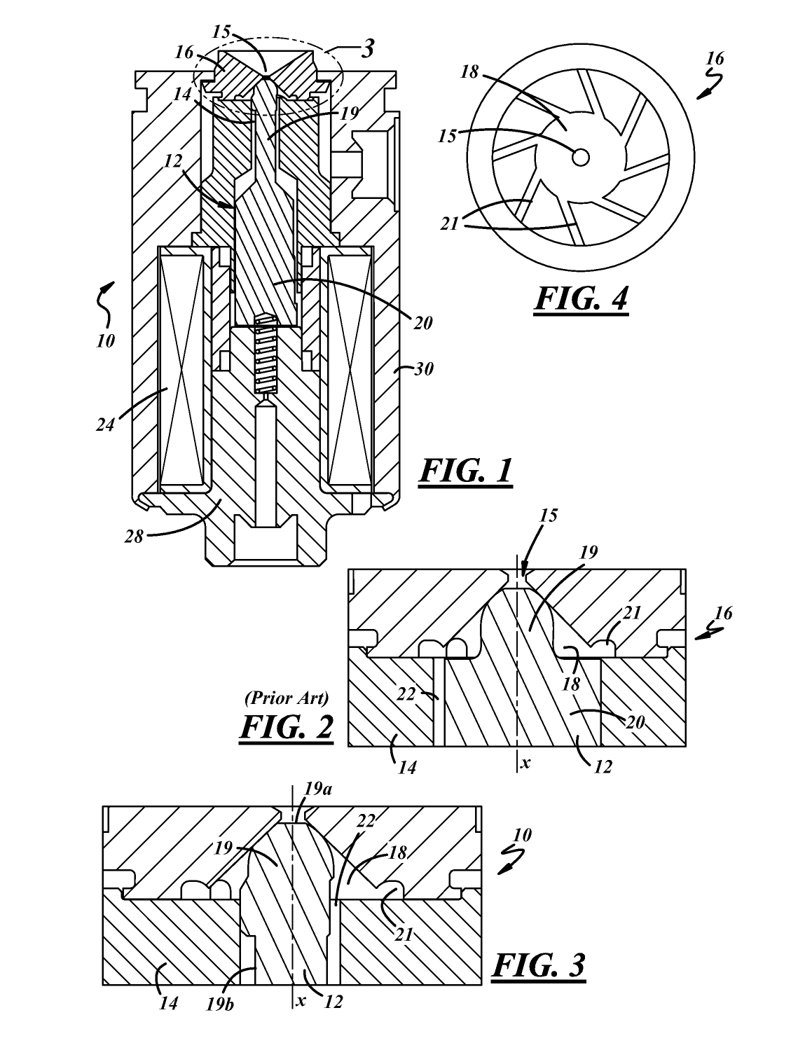

In the current technology, fluid enters the swirl chamber 18 through a plurality of tangential swirl channels 21 disposed about a perimeter of the swirl chamber 18. When the pintle 12 is in the closed position as shown in FIG. 1, fluid from the swirl channels 21 leaves through a flow channel surrounding the pintle 12. The flow channel acts as a return flow path 22 and directs fluid from the swirl chamber 18 to other portions of the atomizer 10. In one embodiment, the return flow path 22 channels fluid to a solenoid 24 to cool it.

As shown in FIG. 2, the pintle 12 in accordance with current technology has a relatively large cross-section, and the return path 22 runs between the pintle 12 and the pintle bearing 14. The swirl channels 21 lie close to the return path 22. This causes excess fluid to exit the swirl chamber 18 down a path that is far from the center line X of the atomizer 10 when the pintle 12 is in the closed position.

Since excess fluid drains through the return path 22 before contributing to swirling in the swirl chamber 18, the fluid in the chamber 18 is essentially static, or “dead,” when the pintle 12 is in the closed position. As a result, when the pintle 12 moves to the open position, static or nearly-static fluid may exit through the exit orifice 15 before it has a chance to accelerate and reach an optimum swirl pattern within the swirl chamber 18. Also, the large cross-sectional area of the return path 22 between the pintle 12 and the pintle bearing 14 may require a secondary flow restrictor downstream to regulate fluid flow.

To overcome these problems, the pintle 12 and at least a portion of the pintle bearing 14 may be redesigned as shown in FIGS. 1 and 3 so that the pintle bearing opening is narrower relative to the swirl chamber 18. More particularly, in one embodiment, the mass of the pintle 12 is reduced by lengthening the nose portion 19. The opening in the pintle bearing 14 is narrowed to accommodate the narrower nose portion 19. A tip 19a of the nose portion 19 opens and closes the exit orifice 15, while sides 19b of the nose portion 19 are surrounded by the pintle bearing 14. For a pintle 12 of a given length, the extended nose portion 19 results in a shorter body portion 20, thereby reducing the overall mass of the pintle 12. This may result in faster response of the pintle 12, which may be particularly advantageous when operating the pintle 12 via PWM control.

Since the pintle 12 and the opening in the pintle bearing 14 are both narrowed, the return path 22 formed between them is closer to the center line X of the atomizer 10 and farther away from the swirl channels 21. Referring to FIG. 3, the return flow path 22 may be located within the perimeter of the swirl chamber 18 (i.e., the circle formed by the contact points between the swirl chamber 18 and the swirl channels 21). In one embodiment, an outer diameter of the return flow path 22 surrounding the pintle 12 is 75% or less of the diameter of a circle formed by the swirl chamber 18 perimeter.

As a result, when the exit orifice 15 is closed, fluid entering the swirl chamber 18 through the swirl channels 21 is forced to remain in the swirl chamber 18 long enough to swirl before draining through the return path 22. The fluid in the swirl chamber 18 therefore may always have at least some degree of swirl when the exit orifice is closed (instead of being completely static), making it more likely for the fluid swirl pattern to be completely formed when the exit orifice 15 is eventually opened. In other words, when the pintle 12 moves to the open position, the fluid in the swirl chamber 18 is already swirling and not static. The fluid can therefore reach its optimal flow pattern more quickly, thereby maintaining high spray quality even when the pintle 12 is PWM-operated.

FIG. 1 illustrates the atomizer 10 in greater detail and also shows the entire pintle 12 according to one embodiment of the invention. As can be seen in FIG. 1, the pintle 12 has the extended nose portion 19 that extends from a body 20. The opening in the pintle bearing 14 may be narrowed to accommodate the extended nose portion 19 because the pintle bearing 14 no longer houses the body 20 of the pintle 12.

The nozzle 16 may be attached to the pintle bearing 14. A core 28 may be disposed near the body 20 support the solenoid 24. In one embodiment, the core 28 is a pole piece, and magnetic forces generated by the solenoid 24 when it is energized pulls the pintle 12 toward the core 28. The core 28 may be a pole piece, but may also serve other functions without departing from the scope of the invention. In one embodiment, at least a portion of the nozzle 16, pintle 12, pintle bearing 14, and core 28 may all be disposed in a housing 30.

The inventive configuration may be used alone or in combination with a modified swirl chamber 18 configuration, such as the one shown in co-pending, commonly-assigned, co-pending U.S. patent application No. [Attorney Docket No: 065445-0405/10-ASD-195(EA)]. Both the pintle 12 configuration shown in the present application and the swirl chamber 18 configuration may improve spray quality either independently or in conjunction with each other. Also, reducing the pintle 12 diameter reduces the cross-sectional flow area between the pintle 12 and the pintle bearing 14, potentially eliminating the need for a downstream flow restrictor to regular fluid flow.

Although the embodiment described above has a flux collector as the pintle bearing 14 and a pole piece as the core 28, those of ordinary skill in the art will understand that these elements can be switched (i.e., the pintle bearing 14 can be the flux collector and the core 28 can be the pole piece). Other modifications may also be made without departing from the scope of the invention.

While the best modes for carrying out the invention have been described in detail, those familiar with the art to which this invention relates will recognize various alternative designs and embodiments for practicing the invention within the scope of the appended claims.

What is claimed is:

1. A pressure swirl atomizer, comprising:
a swirl chamber having an exit orifice;
a plurality of tangential swirl channels disposed about a perimeter of the swirl chamber;
a pintle bearing;
a pintle having a body portion and a nose portion that is narrower than the body portion and that is movable inside the pintle bearing;
a return flow path coupled to the swirl chamber and disposed between the nose portion of the pintle and the pintle bearing.

2. The pressure swirl atomizer of claim 1, wherein the return path is located inside the perimeter of the swirl chamber

3. The pressure swirl atomizer of claim 1, wherein the swirl chamber and the plurality of tangential swirl chambers are disposed in a nozzle.

4. The pressure swirl atomizer of claim 1, wherein the nose portion is cylindrical.

5. The pressure swirl atomizer of claim 1, wherein the return flow path surrounds the pintle, and wherein an outer diameter of the return flow path is 75% or less of a diameter of a circle defined by the perimeter of the swirl chamber.

6. A pressure swirl atomizer, comprising:
a solenoid;
a swirl chamber having an exit orifice;
a plurality of tangential swirl channels disposed about a perimeter of the swirl chamber;
a pintle bearing;
a pintle having a body portion and a nose portion that is narrower than the body portion and that is movable inside the pintle bearing, wherein movement of the pintle is controlled by energization and de-energization of the solenoid;
a return flow path coupled to the swirl chamber and disposed between the nose portion of the pintle and the pintle bearing

7. The pressure swirl atomizer of claim 6, wherein the solenoid controls the position of the pintle via pulse width modulation.

8. The pressure swirl atomizer of claim 6, wherein the perimeter of the swirl chamber forms a circle, and wherein the return path is disposed inside the circle.

9. The pressure swirl atomizer of claim 6, wherein the nose portion is cylindrical.

10. The pressure swirl atomizer of claim 6, wherein the return flow path surrounds the pintle, and wherein an outer diameter of the return flow path is 75% or less of a diameter of a circle defined by the perimeter of the swirl chamber.

11. The pressure swirl atomizer of claim 6, wherein the pintle bearing is one of a flux collector and the pole piece and the core is the other of the flux collector and the pole piece.
